(19) United States
(12) Patent Application Publication
(10) Pub. No.: US 2015/0039326 A1
(43) Pub. Date: Feb. 5, 2015

(54) Measure Calculations Based on a Structured Document

(71) Applicant: Encore Health Resources, LLC, Houston, TX (US)

(72) Inventor: Aaron N. Cutshall, Martinsville, IN (US)

(21) Appl. No.: 13/958,325

(22) Filed: Aug. 2, 2013

(51) Int. Cl. G06Q 50/22; G06Q 10/10

(52) U.S. Cl. CPC G06Q 50/22; G06Q 10/10
USPC 705/2

(57) ABSTRACT

A method and system for calculating a measure result includes a specification loader that receives a measurement specification including a representation of a measure and identifies, based on a measure schema, one or more components in the measurement specification. The system also includes a specification compiler that generates, based on the identified one or more components, executable code. The system further includes an analytics engine that receives one or more parameters to apply to the measurement specification, executes the executable code using the one or more parameters to extract data from a data set, and stores a result set of the executed code in a database.

### FIELD OF THE ART

The present disclosure generally relates to generating executable code, and more particularly to generating executable code based on a structured document.

### BACKGROUND

Clinical quality and utilization measures have been a part of healthcare for many years. These measures help inform and guide healthcare actions and business decisions. With the advent of, for example, the Health Information Technology for Economic and Clinical Health (HITECH) Act, the importance of these measures has increased substantially along with the desire for consistent and timely execution of these measures.

Numerous electronic health record (EHR) vendors in the health industry vie for clients with various features and capabilities to set them apart from their competitors. As systems are developed for the health industry and these systems grow, various versions of systems may be implemented at different times, potentially confusing the users of these systems. Additionally each installation of an EHR is typically customized to suit the needs of the client, reducing the ability of one client to understand an EHR record of another client. To compound the confusion is the fact that many facilities have more than one EHR implemented for different purposes. Accordingly, each installation may be a unique blend of various EHR manufacturers, versions, and customizations.

A conventional solution to address this issue is to implement a general purpose data warehouse onto the EHR platform. This solution, however, may require customization for the given implementation and is therefore not conducive to repeatable or consistent solutions. Another conventional solution is to build a custom data warehouse for a given EHR platform. This solution, however, may still require customization because of the uniqueness of each implementation. These solutions may require considerable time and cost in customizing the system without the benefit of reusability, consistency, and leverage of industry standards.

### BRIEF SUMMARY

This disclosure relates to calculating a measure result. Methods, systems, and techniques for calculating a measure result are provided.

According to an embodiment, a system for calculating a measure result includes a specification loader that receives a measurement specification including a representation of a measure and identifies, based on a measure schema, one or more components in the measurement specification. The system also includes a specification compiler that generates, based on the identified one or more components, executable code. The system further includes an analytics engine that receives one or more parameters to apply to the measurement specification, executes the executable code using the one or more parameters to extract data from a data set, and stores a result set of the executed code in a database.

According to another embodiment, a method of calculating a measure result includes receiving a measurement specification including a representation of a measure. The method also includes identifying, based on a measure schema, one or more components in the measurement specification. The method further includes generating, based on the identified one or more components, executable code. The method also includes receiving one or more parameters to apply to the measurement specification. The method further includes executing the executable code using the one or more parameters to extract data from a data set. The method also includes storing a result set of the executed code in a database.

According to another embodiment, a non-transitory machine-readable medium includes a plurality of machine-readable instructions that when executed by one or more processors are adapted to cause the one or more processors to perform a method including: receiving a measurement specification including a representation of a measure; identifying, based on a measure schema, one or more components in the measurement specification; generating, based on the identified one or more components, executable code; receiving one or more parameters to apply to the measurement specification; executing the executable code using the one or more parameters to extract data from a data set; and storing a result set of the executed code in a database.

### BRIEF DESCRIPTION OF THE DRAWINGS

The accompanying drawings, which form a part of the specification, illustrate embodiments of the invention and together with the description, further serve to explain the principles of the embodiments. In the drawings, like reference numbers may indicate identical or functionally similar elements. The drawing in which an element first appears is generally indicated by the left-most digit in the corresponding reference number.

FIG. 1 is a block diagram illustrating information flows associated with a measure calculation, according to an embodiment.

FIG. 2 is a block diagram illustrating a logical flow of the interrelationship between the various measure artifacts that are created during each measure session, according to an embodiment.

FIGS. 3A and 3B illustrate a document describing the measure schema, according to an embodiment.

FIGS. 4A-4C illustrates an example measure included in an XML document, according to an embodiment.

FIG. 5A-5B illustrates executable code based on a measure and generated by a specification compiler, according to an embodiment.

FIG. 6 is a flowchart illustrating a method of calculating a measure result, according to an embodiment.

FIG. 7 is a block diagram of an electronic system suitable for implementing one or more embodiments of the present disclosure.

### DETAILED DESCRIPTION

### I. Overview

### II. Example System Architecture

A. Data in a Uniform Structure

B. Load Measure Specifications
1. Validate the Measure Specifications
2. Transform the Measure Specifications
3. Ease of Use

C. Client Parameters

### III. Example Documents

### IV. Example Method

### V. Example Computing System

### I. Overview

It is to be understood that the following disclosure provides many different embodiments, or examples, for implementing different features of the present disclosure. Some embodiments may be practiced without some or all of these specific details. Specific examples of components, modules, and arrangements are described below to simplify the present disclosure. These are, of course, merely examples and are not intended to be limiting.

Healthcare “measures” may refer to tools that are used to measure or quantify one or more aspects of healthcare. For example, a measure may include processes, quality care, outcomes, patient perceptions, organizational structure, and/or healthcare systems. A healthcare measure may cover anything that is necessary, for example, to identify a patient that satisfies a particular criterion (e.g., person with diabetes). Healthcare measures may be associated with the ability to provide high-quality healthcare and/or relate to one or more quality goals for healthcare. These goals may include effectiveness, safety, efficiency, patient-centered care, equitable care, and/or timely care. For example, healthcare measures may be used by a healthcare organization to analyze processes and procedures for cost efficiency and effectiveness, for quality improvement programs, public reporting, identify best practices, and pay-for-reporting programs for specific healthcare providers. Depending on what is being measured, the measurement definition and methodology used to arrive at a result of the measurement may be different. Patient clinical data may be used to perform these measurements. For example, the quantity of hospital rooms that are used during the week may be measured. In another example, the quantity of patients having diabetes who have received a retinal eye exam may be measured.

Although the disclosure may describe information about healthcare and a healthcare measure, this is not intended to be limiting and other fields are within the scope of the present disclosure.

A source of information about a measure, its purpose and its goal, may be in the measure definition itself. Various authors write the measure definitions and several organizations review them to ensure that they fit to their requirements. For example, healthcare measures are typically defined and endorsed by major private and governmental organizations such as National Quality Forum (NQF), Centers for Medicare and Medicaid Services (CMS), Healthcare Effectiveness Data and Information Set (HEDIS), and the National Committee for Quality Assurance (NCQA), among others. While typically such measures are defined and endorsed by organizations such as NQF, CMS, HEDIS, NCQA, an organization may also create and use its own measure or customize an existing one for its own purposes.

It may be important to collect data, calculate measures, and report the results of the measures to interested parties. A conventional solution to collect data, calculate measures, and report results is to invest in custom-written applications that are specific to the given data network environment. While this may allow a customized solution to be designed specifically for the targeted environment, the customized solution may not be easily transferred to another environment, if at all. Data collection may become the largest investment in terms of the number of hours involved in the initial identification and collection of the data.

Compounding the issue is the fact that not all EHR systems utilize standard taxonomies and terminologies and therefore local terminologies may be integrated into the data stream for measure calculations. As such, a staff of programmers may be needed not only to write the initial system but also for maintenance and enhancements. Maintenance costs also become problematic because modifications to the custom-written programming may be required when the data source (e.g., an EHR) is upgraded or changed, potentially resulting in numerous cost overruns and implementation delays. With custom reporting, additional programming resources may be required as new measures are needed or existing ones are updated, potentially causing further costs and delays. Additional programming resources may also be required when new reports are needed to evaluate alternative views of existing data.

The present disclosure may provide a modular approach that is a “bolt-on” solution to any environment and may be used with any EHR using any platform. In an embodiment, a transformative layer maps data from an originating EHR system(s) to an internal, unified core structure. Performing translations of taxonomies and terminologies from local to standard value sets and any necessary data transformations may enable embodiments of the disclosure to be a common platform used for all data sources.

A proprietary measure specification that is functional for both clinical quality and utilization measures may be used. The measure specification may be used as the “source code” for generating software that performs measure calculations using standard value sets. This may provide a repeatable solution for all implementations yet may still allow for customizable measures and metrics with minimal data usage complete with data use history and audit trails.

### II. Example System Architecture

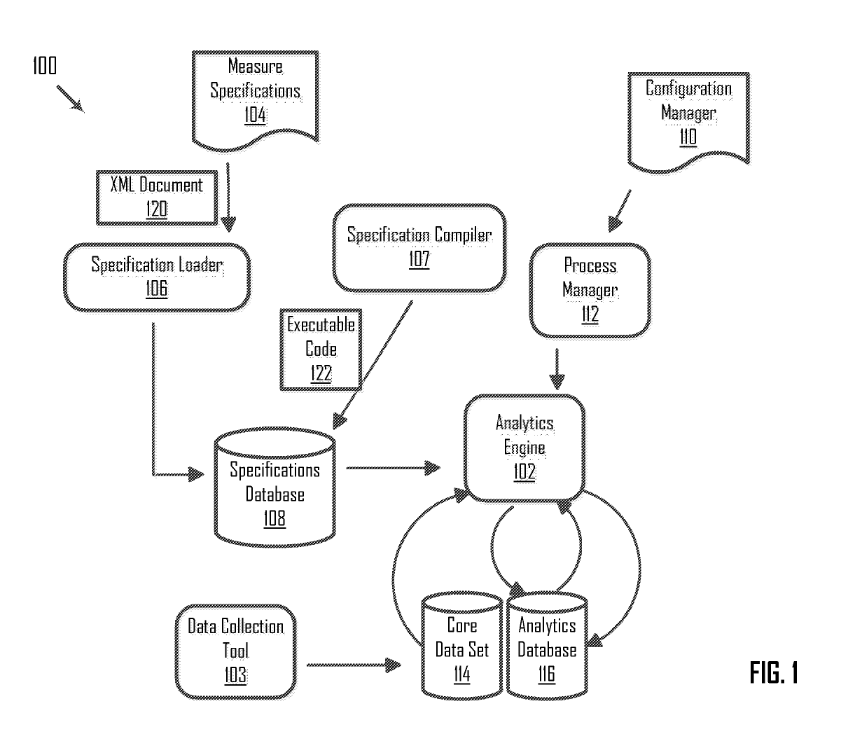

FIG. 1 is a block diagram 100 illustrating information flows associated with a measure calculation, according to an embodiment. Diagram 100 includes an analytics engine 102 and a core data set 114. Analytics engine 102 may obtain patient data from core data set 114 and apply the patient data to various measures to determine a result set. The measures may be defined in a structured manner to represent data elements and rules in a prescribed and specific manner. Analytics engine 102 may then apply the data elements and rules against the patient data to calculate the measure.

### A. Data in a Uniform Structure

Core data set 114 may include data that is obtained from the client. In an embodiment, core data set 114 stores homogenized patient data from the client. A client's patient data may be collected from various source systems and stored in different formats. For example, a client's medical records may be stored in different databases, such as an EPIC® database or CERNER® database, among others. A data collection tool 103 may be used to identify what data to collect for that client and where the data is so that it can be gathered for the measure specification. Further, multiple versions of a measure may be implemented concurrently to allow different facilities within an organization to use different versions or customizations.

Data collection tool 103 may homogenize the data (e.g., from EPIC® database or CERNER® database) to a uniform structure that analytics engine 102 understands. In this way, it may be unnecessary for analytics engine 102 to be knowledgeable of all potential business sources and their formats. In an example, the data collection tool is a transformative layer that maps the data in disparate formats and that originate from EHR systems to the uniform structure understood by analytics engine 102, and the data collection tool loads the data in the uniform structure into core data set 114.

Additionally, different hospitals and sectors within a hospital may code terms differently. Data collection tool 103 may change the local definitions into standard definitions. Accordingly, analytics engine 102 may work with the uniform structure and a standard terminology set. It should also be understood, however, that analytics engine 102 may work with data stored in a database that is not of a uniform structure. In this scenario, analytics engine 102 may understand more than one data format.

### B. Load Measure Specifications

Diagram 100 also includes one or more measure specifications 104 and a specification loader 106. A measure specification describes a measure in a clear and precise manner as prescribed by the measure schema definition. The measure specification is the logic for what a particular measure is supposed to do and may be created based on the information in a defined measure. In an example, the measure specification may be used to determine what data is used to arrive at a particular measure calculation.

Each measure may be represented in a simple text document. A measure specification may describe a measure in a document markup language that is a structured document (e.g., a form). The document markup language may be, for example, Extensible Markup Language (XML), and each measure specification may be represented as a separate XML document 120. Although the disclosure may describe the document markup language as being XML, this is not intended to be limiting. The document markup language may be any highly structured document markup language.

### 1. Validate the Measure Specifications

A measure schema includes a set of rules (e.g., syntactical structure rules and format) for the measure specification. In an embodiment, specification loader 106 receives a measurement specification including a representation of a measure, and the measurement specification may be XML document 120. Specification loader 106 may validate XML document 120 against the measure schema to ensure that XML document 120 conforms to the set of rules. For example, the measure schema may be thought of as a blueprint on how to create a measure specification and the proper structure of XML document 120 to identify particular components in the measure specification. The measure schema for XML document 120 may be an XML Schema (e.g., XML Schema Definition (XSD)) file that is used to ensure that the syntactical structure of the measure specification is correct. In this way, specification loader 106 may identify various components in XML document 120 based on the measure schema to which specification loader 106 expects XML document 120 to conform and loads that information into specifications database 108 in a format that analytics engine 102 understands.

The measure schema provides a generalized computational scheme that allows the client to calculate different measures pertaining to the operation of a business (e.g., healthcare business). Although each measure specification may be different because different measures are being calculated, each measure specification may follow the same rules set forth by the measure schema. As such, the measure schema is not specific to any particular measure, but rather may be applied to any given measure. In an example, an XML document may include a measure specification for measuring patients with diabetes 18 years old or older, and another XML document may include a measure specification for measuring the satisfaction of patients who have stayed in the hospital for more than three days. Each of these measure specifications are directed to different measures, but each of the XML documents may be structured based on the same measure schema. Thus, multiple documents may follow the same format yet contain different content for different measures.

Further, embedded Schematron rules may validate the logical components of a measure to ensure proper usage of optional components and to check for logical correctness (e.g., a beginning date not occurring after an ending date). The embedded Schematron rules may also be used as a guide by specification loader 106 to ensure logical correctness.

### 2. Transform the Measure Specifications

Before a measure is calculated, specification loader 106 loads measure specification 104 into specifications database 108 in a format that is understood by analytics engine 102. Specification loader 106 may effectively transform measure specification 104 (e.g., XML document 120) into a database structured format that is used by a specification compiler 107 to generate executable code 122. Thus, the XML representation of the measure calculation may be transformed into a database stored procedure that performs the calculation against core data set 114 when called upon by analytics engine 102. In an example, specification compiler 107 may generate, based on one or more components in the measure specification identified by specification loader 106, executable code. Specification compiler may compile the executable code and store the compiled code in specifications database 108.

In an embodiment, specification loader 106 includes instructions on how to parse XML document 120 (e.g., from the measure schema). Specification loader 106 reads XML document 120 and identifies components in XML document 120 based on the expected measure schema structure. Specification loader 106 parses XML document 120 into specifications database 108, and specification compiler 107 generates executable code 122 based on the rules in the measure specification and the measure schema to which specification loader 106 expects XML document 120 to conform. In this way, it may be unnecessary for the client to write software code to calculate the measure. Rather, specification loader 106 may generate executable code 122 to perform the measure calculation based on the information extracted from XML document 120. The generated code follows the rules in the measure specification and converts higher-level definitions into specific queries against core data set 114 to produce the measure calculations. Specification compiler 107 may compile the internally generated code, thus allowing a measure to be used repeatedly without having to be re-interpreted or re-compiled (unless a modification is made to the measure specification). Specification compiler 107 may store executable code 122 in specifications database 108 to be used by analytics engine 102 to perform the measure calculation. Specification compiler 107 may also store executable code 122 in a database different from specifications database.

In an example, a measure determines patient encounters with a particular criterion and XML document 120 describes how to determine these patient encounters with the particular criterion. Specification loader 106 may read XML document 120, identify the particular criterion based on the measure schema, and load the measure definition into specifications database 108. Specification compiler 107 generates executable code (e.g., relational database stored procedure) including one or more queries that searches core data set 114 for patient encounters matching that particular criterion. Analytics engine 102 then executes the code to perform the measure calculation.

In an embodiment, specifications database 108 is a relational database and executable code 122 is one or more stored procedures stored in specifications database 108. Storing the code inside specifications database 108 may have advantages of performance gains due to, for example, avoiding the compilation of the code each time it is executed and avoiding the recreation of the commands executed against the database. As such, specification compiler 107 may generate the stored procedures and store them in specifications database 108. The stored procedures may be written with data optimization and performance in mind. A minimal, targeted approach to data usage may allow measure calculations to execute in an environment with minimal impact to other systems on the network. In an example, when placed onto a dedicated server, the only network impact may be in data gathering from source systems and publication of results (if on another server).

In an example, specifications database 108 is a Structured Query Language (SQL) database, and XML document 120 is parsed and translated into a series of queries specific to the SQL database (e.g., SQL server stored procedures). This is not intended to be limiting, however, and specifications database 108 may be a database different from an SQL database (e.g., ORACLE® database). Trademarks are the property of their respective owners. An output of specification compiler 107 may change based on the type of database server used.

### 3. Ease of Use

Using the techniques provided in the present disclosure, it may be unnecessary for analytics engine 102 to process XML document 120. Rather, specification loader 106 parses XML document 120 and interprets it for analytics engine 102. Specification compiler 107 may then generate executable code based on the interpretation and store the compiled code in specifications database 108 to be executed by analytics engine 102. As such, it may be unnecessary to go through the validation, interpretation, and break down process every time measure specification 104 is run. This may improve overhead costs and avoid other potential problems. Further, the measure specification infrequently changes. A measure specification typically changes only once a year, if even that much. Accordingly, by having specification loader 106 and specification compiler 107 process XML document 120 once and as long as no changes are made to the measure specification in XML document 120, analytics engine 102 may continue to use the compiled executable code.

In an embodiment, a tool (e.g., text editor or measure editor) may be provided to the client such that the client may create the measure specification without having knowledge of the rules or structure of the measure schema. For example, a computing device (e.g., desktop or laptop) may include a software module that enables input from the client to be received and that creates a measure specification based on the client's input. The software module may also validate the measure specification against the measure schema.

Further, XML document 120 is human readable. If a change is made to a measure specification, XML document 120 may be manipulated to include the changed measure specification. Previously, such changes required a staff of programmers to write the software based upon the measure specification, costing time and money. Further, if changes needed to be made to the measure specification, a programmer would be asked to make that change in the code. In contrast, the measure specification may be a structured document (e.g., XML document 120) that may be thought of as similar to filling out a form with instructions. Accordingly, a person having insufficient programming knowledge of writing code for the measure specification, but sufficient clinical knowledge of the aspects of a measure, may be able to use embodiments described in the present disclosure to create a measure calculation.

Specification loader 106 may parse the measure specification and specification 107 may generate the code used to create the measure calculation. Analytics engine 102 may include flexible and scalable components such that it may be unnecessary to modify analytics engine 102 when a measure is changed or added because the measure may be modified or added via measurement specification 104. Thus, measures may be added by non-programmers. The measure specifications may be configurable by a user with limited programming knowledge. The user may then update the measure specification in specifications database 108 by loading an updated XML document into specification loader 106, which then parses the updated XML document including the modified measure specification into specification database 108 such that specification compiler 107 can generate updated executable code that calculates the measure. As such, analytics engine 102 may obtain the updated executable code for the measure from specifications database 108 and have the latest set of instructions on how to calculate that particular measure.

Additionally, a client may send the already written measure specification (e.g., XML document 120) to one or more other users to load into their analytics engine and process against their data. Moreover, the user may develop a new measure specification and send it (e.g., via e-mail) to one or more other users to load into their analytics engine and process against their data.

### C. Client Parameters

Diagram 100 also includes a configuration manager 110 and process manager 112. In an embodiment, configuration manager 110 is a user interface for the management of the measure calculation process and enables a client to enter one or more criterion for the measure calculation. Configuration manager 110 may be a graphical user interface or a command line interface that enables the client to specify criteria specific to the client's implementation. For example, configuration manager 110 may enable the client to specify a timeframe for how often a measure calculation should be calculated (e.g., one week apart or every three weeks). In this example, the measure calculation process may be a “set and forget” system in which measures are scheduled in advance for selected client facilities on a daily, weekly, or monthly basis as requested by business requirements. This is not intended to be limiting, and configuration manager 110 may also be used in manual operations to perform ad-hoc or “what-if” scenarios.

Additionally, configuration manager 110 may allow flexibility for multiple facilities, multiple programs, and multiple measures. In an example, configuration manager 110 may identify which measures a particular client would like to run, the timeframe, data ranges, and facilities involved, and other criteria specific to the client's implementation. Configuration manager 110 may send the criteria specific information for the measure calculation to process manager 112. Process manager 112 analyzes this information and passes it along to analytics engine 102. In an example, process manager 112 may identify the patient data necessary to calculate the measure, which measures to calculate, and when to calculate the measures. Process manager 112 may specify that information in one or more parameters passed to analytics engine 102. Analytics engine 102 may receive the parameters to apply to the measurement specification and executes the executable code using the parameters to extract data from core data set 114. Analytics engine 102 may store a result set of the executed code in analytics database 116.

In an example, the measure may calculate information about patients who have had a stroke. Process manager 112 passes this information to analytics engine 102. Accordingly, analytics engine 102 may be selective in the data it selects and select only records from core data set 114 of patients who have had strokes. If analytics engine 102 comes across a record for a patient with a broken arm, for example, analytics engine 102 will ignore this record because it is not part of the measure.

In an embodiment, all of the components in FIG. 1 execute on the same computing device. The components may be programmed using a programming language. For example, the components may be programmed using MICROSOFT® C# or JAVA®. In another embodiment, one or more of the components in FIG. 1 may execute on different computing devices that are coupled over a network (not shown) and that communicate with each other via the network. The network may include various configurations and use various protocols including the Internet, World Wide Web, intranets, virtual private networks, wide area networks, local networks, private networks using communication protocols proprietary to one or more companies, cellular and other wireless networks, Internet relay chat channels (IRC), instant messaging, simple mail transfer protocols (SMTP), Ethernet, Wi-Fi and HTTP, and various combinations of the foregoing.

### D. Measure Calculation

Analytics engine 102 may obtain the specific criteria information for the measure calculation from process manager 112, the executable code based on the measure specification from specifications database 108, and the data from core data set 114 to perform the measure calculation and produce a result set (e.g., a measure result). Analytics engine 102 stores the result set from the measure calculation into analytics database 116. A portion of the result set stored in analytics database 116 may be reused during the measure calculation.

The structure of a healthcare measure may include general information, the initial population, denominator, and numerator. The general information may be the “header” of a measure and may include information about the measure such as the description, purpose, and/or rationale of the measure. The initial population may refer to the general description or identification of the initial set of patients, encounters, or orders that are being measured. Some measure requirements may not explicitly have an initial population but may have a denominator, which may be used to infer the initial population. The denominator may be the basis for what is to be measured. Some measure requirements may not have the denominator but may have an initial population with the denominator implied from the initial population. The numerator may describe what is to be measured once the denominator has been determined. Other components of a healthcare measure may also include elements, derivations, and assertions that are used along with inclusion and/or exclusion rules. These will be explained in more detail below. The use of these various components and their combination may allow various measures to cover a wide variety of purposes and goals. Many measures that cover the same or similar subject having the same or similar goal may be somewhat similar, yet others can be different in form and function.

At the highest level, a measure may include several sections. The first section may include measure information that is for informational purposes and does not contribute to the calculation of the measure (e.g., description, rationale, authors, etc.). The following three sections may include a population section, denominator section, and numerator section. These three sections, while structured similarly, may serve different purposes. The population section may include an identification of the initial population, the denominator section may include a further refinement or qualification of the population to be measured, and the numerator section may include an end result or purpose of the measure.

Various measure constructs exist that may be persisted after each session of measure calculations for direct reporting or for tracing measure results back to the original data. For example, an element may be a measure construct (e.g., criterion) that indicates the measure evidence to be selected from the evidence pool, a derivation may be a measure construct that is calculated based on the measure evidence, and an assertion may be a measure construct that answers specific questions using both the measure evidence and derivations.

The last component of the measure may include rules. In an example, rules are logical sequences that use logical operators (e.g., AND, OR, and NOT) with assertions and other rules. This recursive nature allows building complex rule structures such as, for example, (X AND (Y OR Z)). The base rules in each section (e.g., population, denominator, and numerator sections) may be, for example, inclusion and exclusion to determine which records to keep (inclusion) and which records to keep out (exclusion).

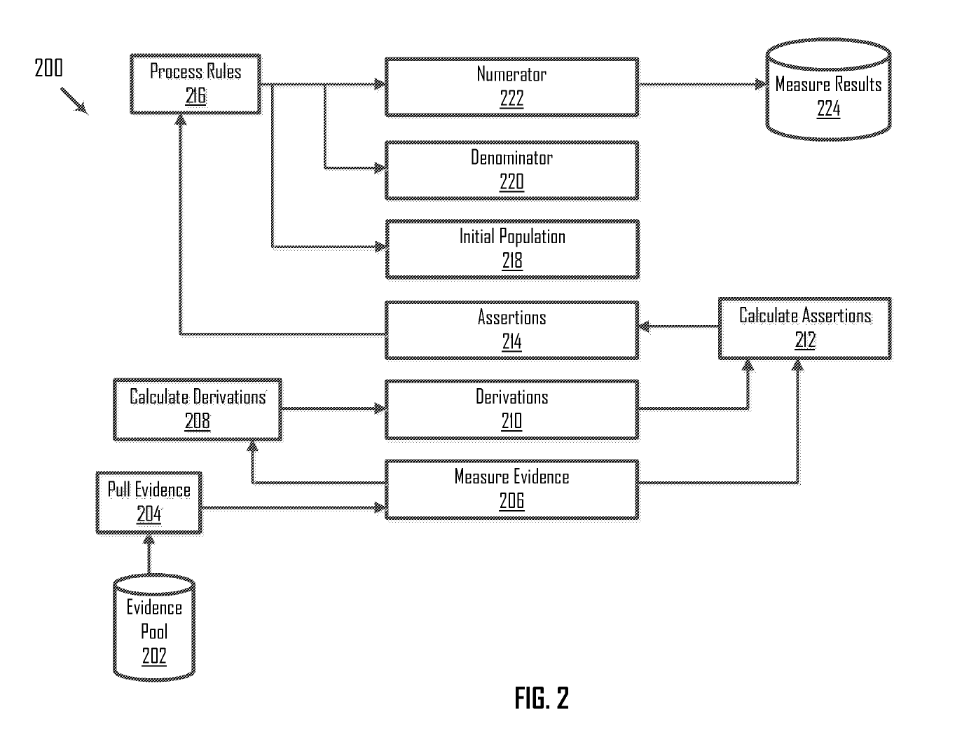

FIG. 2 is a block diagram 200 illustrating a logical flow of the interrelationship between the various measure artifacts that are created during each measure session, according to an embodiment. Analytics engine 102 may use the compiled executable code based on measure specification 104 (e.g., stored procedures) to generate measure evidence 206, derivations 210, and assertions 214 to arrive at initial population 218, denominator 220, and numerator 222.

Diagram 200 includes core data set 114, which includes data from the client. Evidence pool 202 is extracted from core data set 114 and includes all of the data needed to calculate a measure. In an example, the measure may determine the quantity of patients diagnosed with diabetes and 18 years old or over and have had a retinal eye exam within the past year. In this example, the evidence pool record of all patients diagnosed with diabetes from core data set 114.

Analytics engine 102 may pull data from evidence pool 202 that satisfy a given criterion. Data may be selected from evidence pool 202 based upon specific requirements identified in the measure (e.g., timing, relationships to other data, value sets, etc.) to determine measure evidence 206. For example, patient records of patients diagnosed with diabetes and 18 years old or over and those who have had retinal eye exams within the past year may be identified and selected from evidence pool 202 to determine measure evidence 206.

At an action 208, analytics engine 102 may calculate derivations 210. The derivation calculation may be based on measure evidence 206. At an action 212, analytics engine 102 may calculate assertions 214. Based on measure evidence 206 and/or derivations 210 that were calculated, assertions 214 may be calculated. An assertion may be thought of as a question that is posed. For example, an assertion may ask whether the patient has had a retinal eye exam within the past year. Based upon the specific measure requirement, the answer to this assertion may be determined based on derivations 210, which is based on measure evidence 206, or directly against measure evidence 206. In diagram 200, measure evidence 206 and derivations 210 are used to answer assertions 214.

After the results of assertions 214 are determined, at an action 216, analytics engine 102 may process a set of rules to determine which patients belong in initial population 218, denominator 220, and numerator 222. In keeping with the example above, a ratio may be determined (e.g., for reporting purposes) of how many patients have been diagnosed with diabetes, are 18 years old or older, and have had a retinal eye exam within the past year (the numerator), to how many patients have been diagnosed with diabetes 18 years old or older (the denominator).

Inclusion and exclusion rules may be applied to identify the initial population 218. Records from initial population 218 that were included but not excluded may become the basis for denominator 220. Inclusion and exclusion rules may then be applied to identify denominator 220. Records from denominator 220 that were included but not excluded may be passed to numerator 222. Records not excluded from numerator 222 are identified as having passed or failed the numerator via the inclusion rule to determine a measure result. The measure result may be stored in measure results database 224. Accordingly, the measure results may be derivative of numerator 222 and denominator 220. In the example above, a measure result may be 68 percent, indicating that for every 100 patients diagnosed with diabetes 18 years old or older, 68 have had a retinal eye exam within the past year.

Further, interested parties (e.g., hospitals and medical groups) may make use of the data to improve patient healthcare and provide a proactive environment. Additional actions may be performed based on a measure result. Additional actions may include, for example, generating a report that displays information related to the measure (e.g., passage rate, patient names, date the patient was diagnosed with diabetes) and contacting patients with diabetes who have not had their retinal eye exam within the past year to request that they take their retinal eye exam. This assists in providing a proactive environment that improves patient healthcare. Further, reports may be generated and provided to the interested parties to conduct more analysis on the patient records or to identify patterns in patients. Dependable and consistent reporting capabilities may be provided for all implementations. For example, high-level reports with easily understood graphics with drill-down capabilities to low-level data may be produced. The low-level data may be sliced and diced in multiple views.

### III. Example Documents

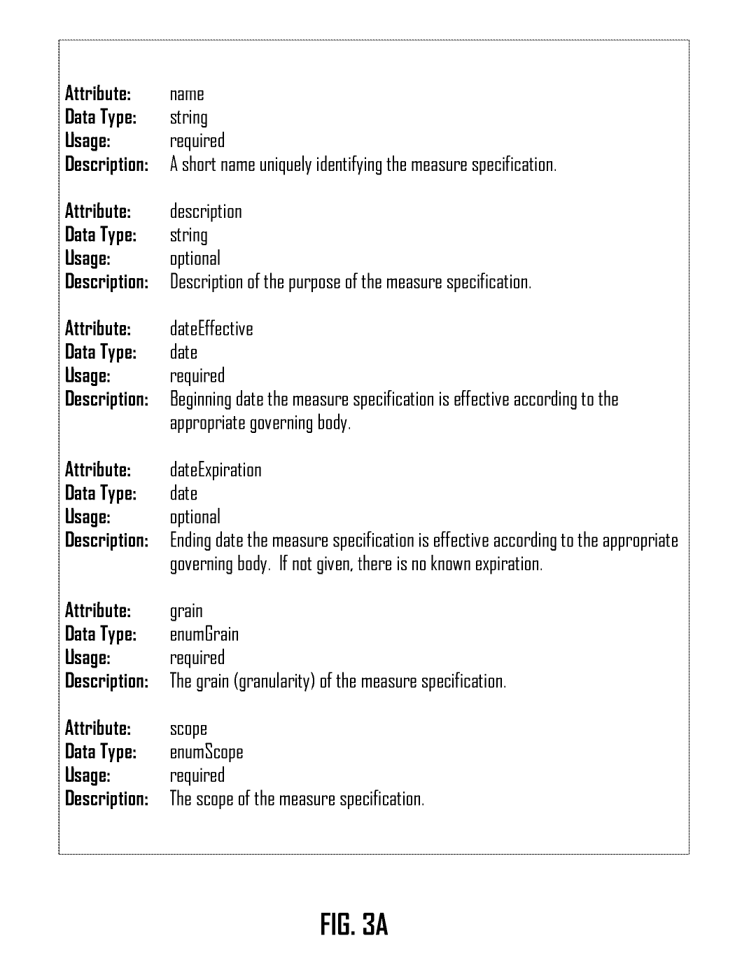

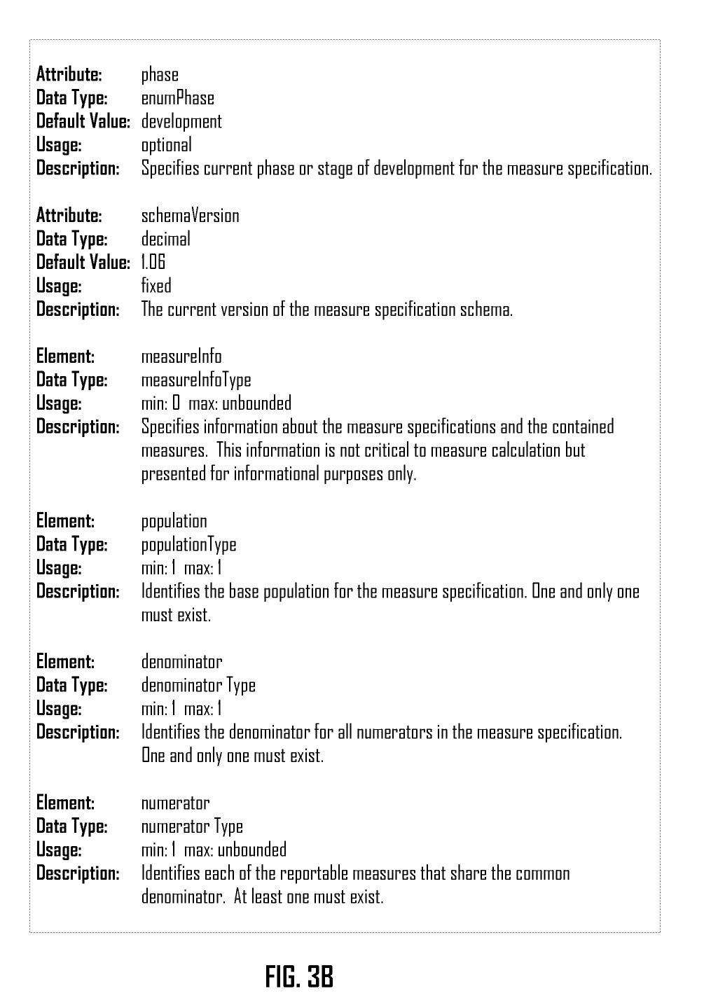

FIGS. 3A and 3B illustrate a document describing the measure schema, according to an embodiment. In FIGS. 3A and 3B, a measure element is the root definition for the measure specification document. The measure element has attributes name, description, dateEffective, datExpiration, grain, scope, phase, schemaVersion, measureInfo, population, denominator, and numerator. Multiple reportable measures may be defined in a single measure specification document. The numerators (reportable measures) may use the same denominator and by extension the same population.

In FIGS. 3A and 3B, the measure schema is an XML schema that presents entities in order of their usage within a measure specification (e.g., attributes first then elements following) and other entities referenced are defined afterwards. In another example, an XML schema may require that entities such as elements and attributes be defined prior to their reference. Each of the elements in the XML schema may be treated as a separate and distinct entity but not inclusive. An element generated in one stage (e.g., population) may be referred to later (e.g., numerator). In other words, everything may be defined at a global level for the specification without scoping. Scoping may restrict the data. For example, a restriction may be that only data that is included and not excluded from a stage is passed on to the next stage. Based upon the measure grain, data that is identified in the population and is included and not excluded may be passed on to the denominator and used as the base set of records for that stage. Records that are included and not excluded in the denominator may be passed on to the numerator and used as the base set of records for that stage. Records that are included and not excluded in the numerator may be “passes” for the measure.

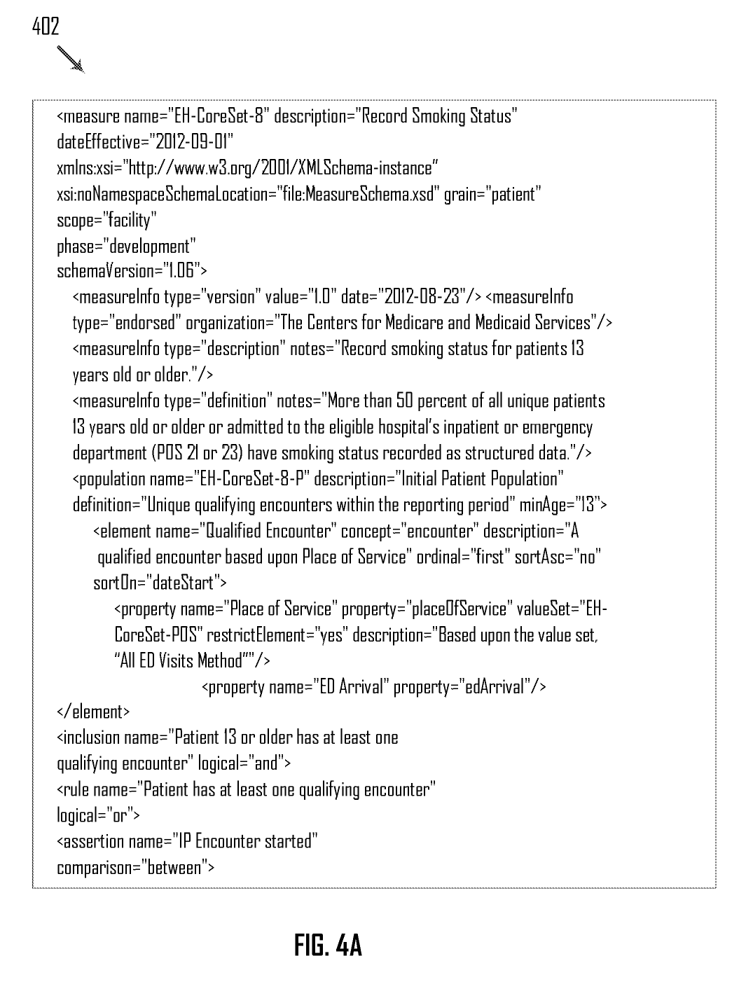

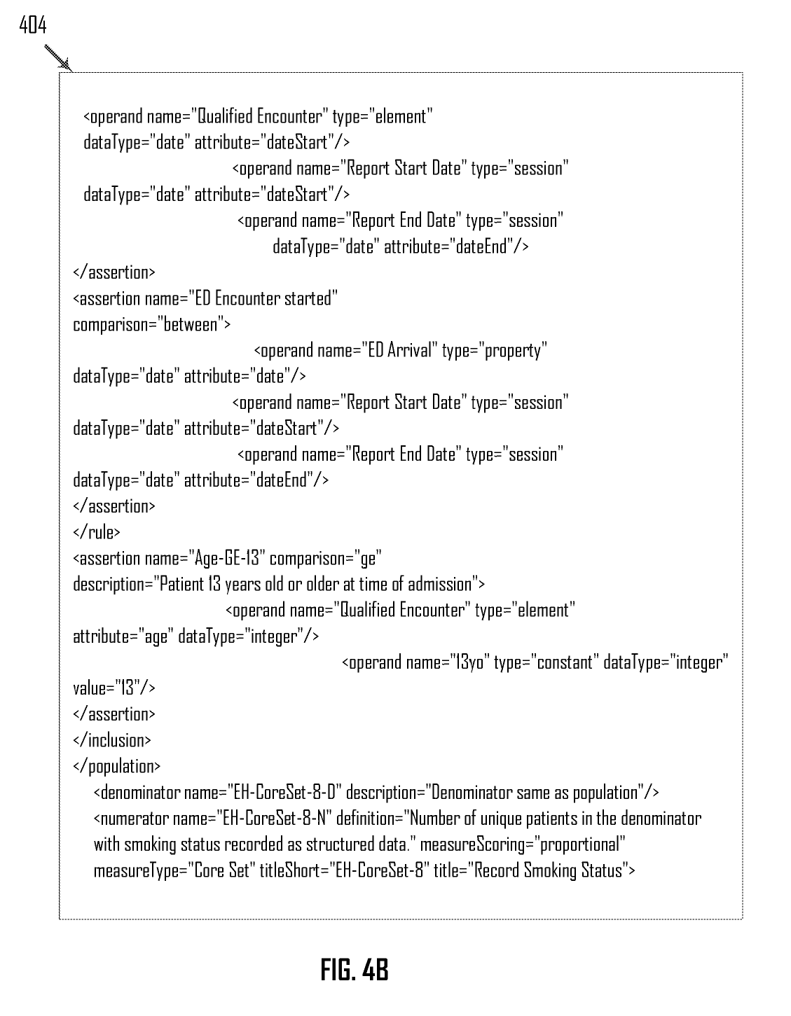

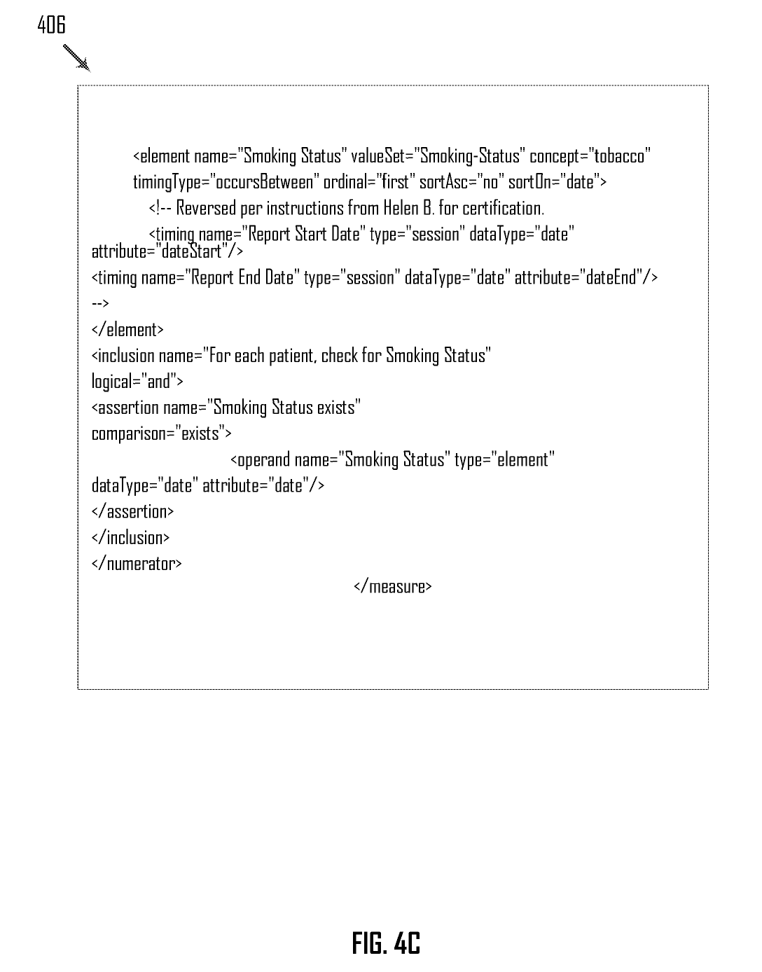

FIGS. 4A-4C illustrates an example measure 402, 404, 406 included in an XML document, according to an embodiment. Measure 402 checks for the recording of the smoking status of patients.

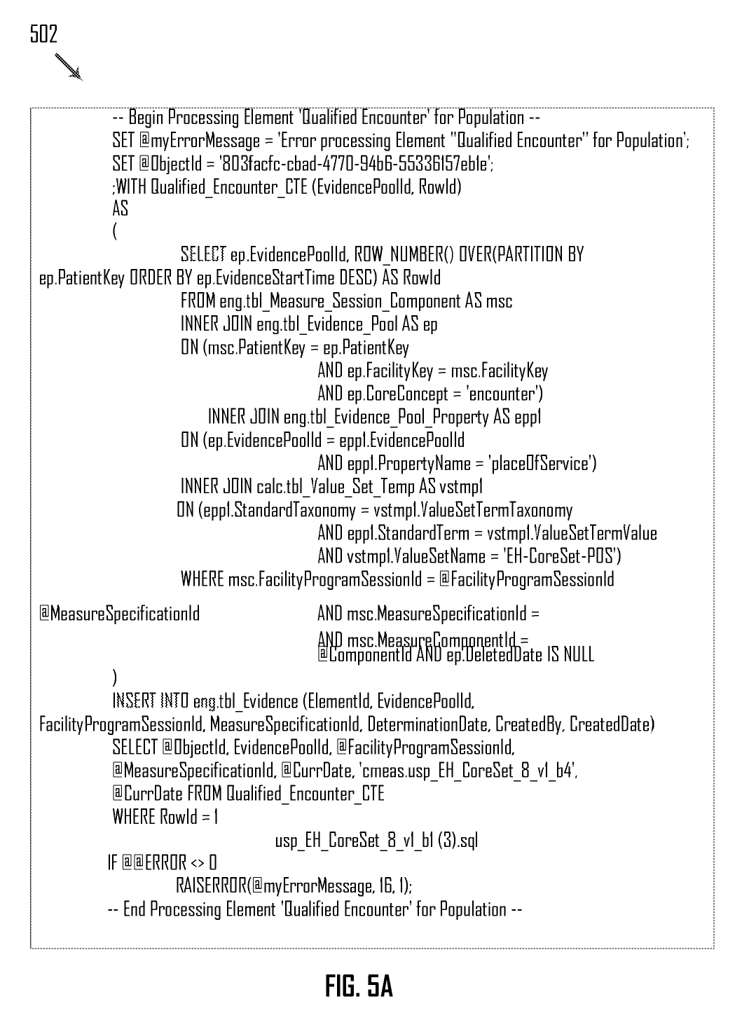

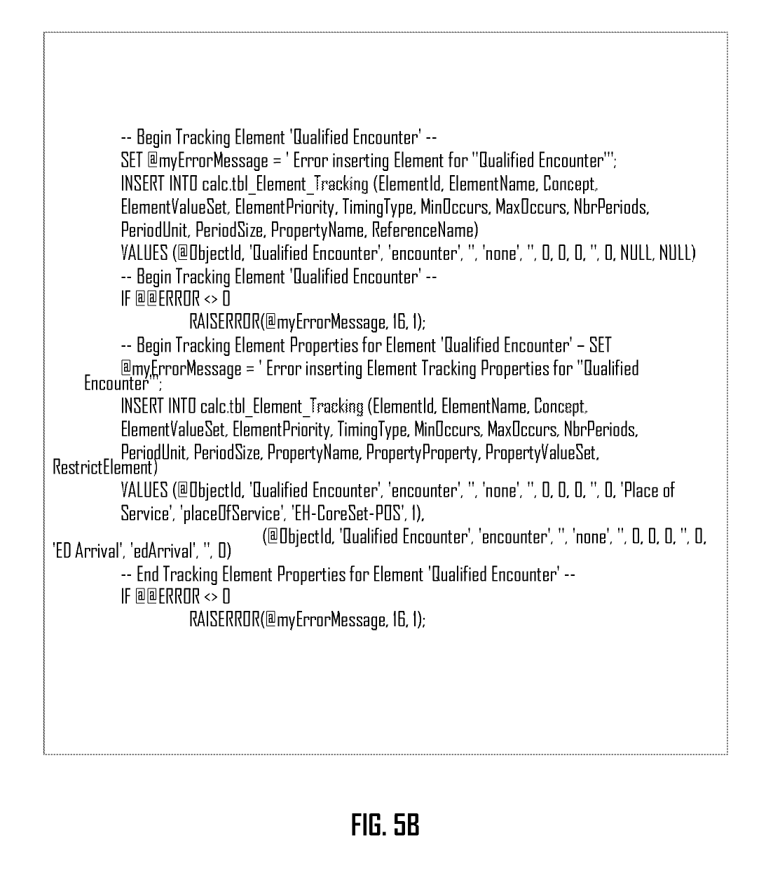

FIG. 5 illustrates executable code based on example measure 402, 404, 406 and generated by specification compiler 107, according to an embodiment. The resulting executable code is one or more SQL server stored procedures.

As discussed above and further emphasized here, FIGS. 1-2, 3A-3B, and 4-5 are merely examples, which should not unduly limit the scope of the claims.

### IV. Example Method

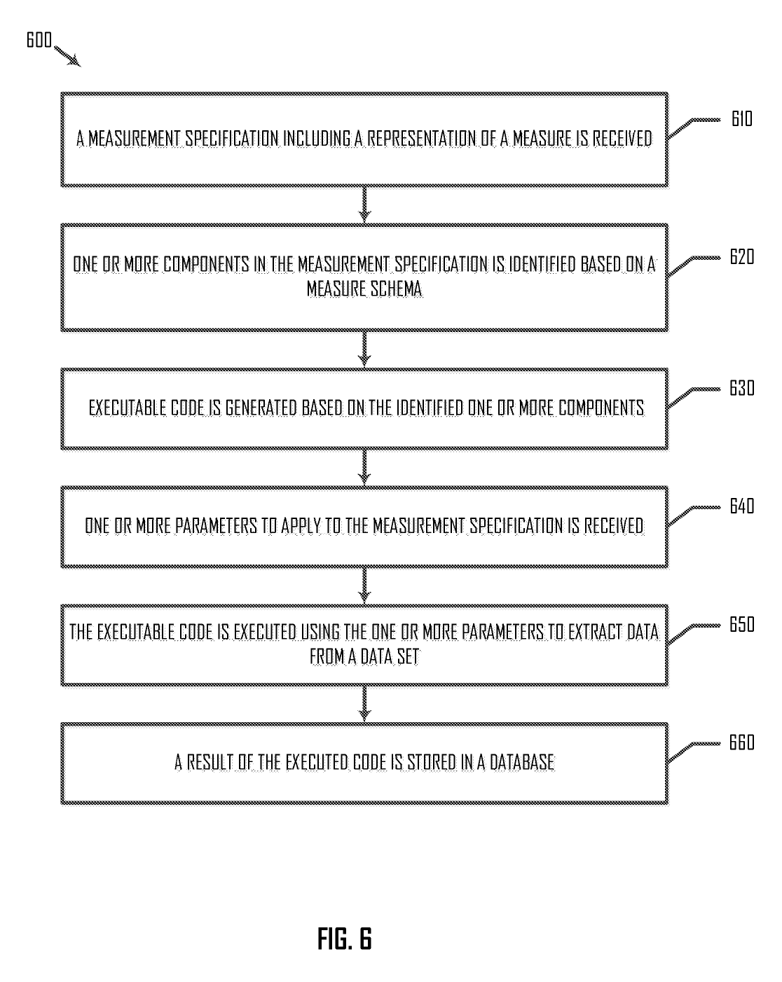

FIG. 6 is a flowchart illustrating a method 600 of calculating a measure result, according to an embodiment. Method 600 is not meant to be limiting and may be used in other applications.

Method 600 includes steps 610-660. In a step 610, a measurement specification including a representation of a measure is received. In an example, specification loader 106 receives measurement specification 104 including a representation of a measure. In a step 620, one or more components in the measurement specification is identified based on a measure schema. In an example, specification loader 106 identifies, based on a measure schema, one or more components in the measurement specification.

In a step 630, executable code is generated based on the identified one or more components. In an example, specification compiler 107 generates, based on the identified one or more components, executable code. In a step 640, one or more parameters to apply to the measurement specification is received. In an example, analytics engine 102 receives one or more parameters to apply to the measurement specification. In a step 650, the executable code is executed using the one or more parameters to extract data from a data set. In an example, analytics engine 102 executes the executable code using the one or more parameters to extract data from core data set 114. In a step 660, a result set of the executed code is stored in a database. In an example, analytics engine 102 stores a result set of the executed code in analytics database 116.

It is also understood that additional method steps may be performed before, during, or after steps 610-660 discussed above. It is also understood that one or more of the steps of method 600 described herein may be omitted, combined, or performed in a different sequence as desired.

### V. Example Computing System

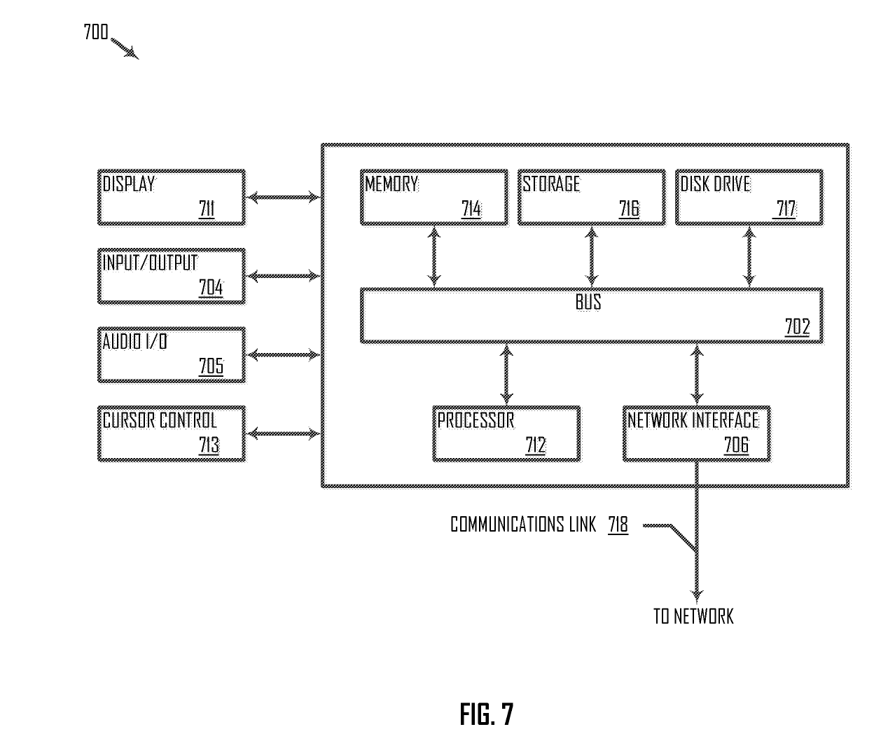

FIG. 7 is a block diagram of a computer system 700 suitable for implementing one or more embodiments of the present disclosure. In various implementations, a component in FIG. 1 executes on a computing device. The computing device may include one or more processors, and may additionally include one or more storage devices each selected from a group consisting of floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read. The one or more storage devices may include stored information that may be made available to one or more computing devices and/or computer programs (e.g., clients) coupled to the client or server using a computer network (not shown). The computer network may be any type of network including a LAN, a WAN, an intranet, the Internet, a cloud, and/or any combination of networks thereof that is capable of interconnecting computing devices and/or computer programs in the system.

Computer system 700 includes a bus 702 or other communication mechanism for communicating information data, signals, and information between various components of computer system 700. Components include an input/output (I/O) component 704 that processes a user action, such as selecting keys from a keypad/keyboard, selecting one or more buttons or links, etc., and sends a corresponding signal to bus 702. I/O component 704 may also include an output component such as a display 711, and an input control such as a cursor control 713 (such as a keyboard, keypad, mouse, etc.). An optional audio input/output component 705 may also be included to allow a user to use voice for inputting information by converting audio signals into information signals. Audio I/O component 705 may allow the user to hear audio. A transceiver or network interface 706 transmits and receives signals between computer system 700 and other devices via a communication link 718 to a network. In an embodiment, the transmission is wireless, although other transmission mediums and methods may also be suitable. A processor 712, which may be a micro-controller, digital signal processor (DSP), or other processing component, processes these various signals, such as for display on computer system 700 or transmission to other devices via communication link 718. Processor 712 may also control transmission of information, such as cookies or IP addresses, to other devices.

Components of computer system 700 also include a system memory component 714 (e.g., RAM), a static storage component 716 (e.g., ROM), and/or a disk drive 717. Computer system 700 performs specific operations by processor 712 and other components by executing one or more sequences of instructions contained in system memory component 714. Logic may be encoded in a computer readable medium, which may refer to any medium that participates in providing instructions to processor 712 for execution. Such a medium may take many forms, including but not limited to, non-volatile media, volatile media, and transmission media. In various implementations, non-volatile media includes optical, or magnetic disks, or solid-state drives, volatile media includes dynamic memory, such as system memory component 714, and transmission media includes coaxial cables, copper wire, and fiber optics, including wires that include bus 702. In an embodiment, the logic is encoded in non-transitory computer readable medium. In an example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 700. In various other embodiments of the present disclosure, a plurality of computer systems 700 coupled by communication link 718 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also where applicable, the various hardware components and/or software components set forth herein may be combined into composite components including software, hardware, and/or both without departing from the spirit of the present disclosure. Where applicable, the various hardware components and/or software components set forth herein may be separated into sub-components including software, hardware, or both without departing from the spirit of the present disclosure. In addition, where applicable, it is contemplated that software components may be implemented as hardware components, and vice-versa.

Application software in accordance with the present disclosure may be stored on one or more computer readable mediums. It is also contemplated that the application software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Changes may be made in form and detail without departing from the scope of the present disclosure. Thus, the present disclosure is limited only by the claims.

What is claimed is:

1. A system for calculating a measure result, the system comprising:
a specification loader that receives a measurement specification including a representation of a measure and identifies, based on a measure schema, one or more components in the measurement specification;
a specification compiler that generates, based on the identified one or more components, executable code; and
an analytics engine that receives one or more parameters to apply to the measurement specification, executes the executable code using the one or more parameters to extract data from a data set, and stores a result set of the executed code in a database.

2. The system of claim 1, wherein the measurement specification is an XML document.

3. The system of claim 1, wherein the measurement specification is human readable.

4. The system of claim 1, wherein the specification compiler compiles the executable code and stores the compiled executable code in a second database.

5. The system of claim 4, wherein the executable code includes one or more relational database stored procedures.

6. The system of claim 1, wherein the specification loader parses, based on the measure schema, the measurement specification, and identifies, based on the measure schema, the one or more components in the measurement specification.

7. The system of claim 1, wherein the analytics engine extracts an evidence pool from the data set to determine measure evidence and calculate derivations based on the measure evidence.

8. The system of claim 1, wherein the analytics engine calculates assertions based on the derivations and measure evidence.

9. The system of claim 1, wherein the analytics engine processes a set of rules based on the assertions to determine an initial population, numerator, and denominator.

10. The system of claim 1, wherein the analytics engine determines a measure result based on the numerator and denominator.

11. A method of calculating a measure result, the method comprising:
receiving a measurement specification including a representation of a measure;
identifying, based on a measure schema, one or more components in the measurement specification;
generating, based on the identified one or more components, executable code;
receiving one or more parameters to apply to the measurement specification;
executing the executable code using the one or more parameters to extract data from a data set; and
storing a result set of the executed code in a database.

12. The method of claim 11, wherein the measurement specification is an XML document.

13. The method of claim 11, wherein the measurement specification is human readable.

14. The method of claim 11, further comprising:
compiling the executable code; and
storing the compiled code in a second database.

15. The method of claim 11, wherein the generating includes generating one or more stored procedures.

16. The method of claim 11, further comprising:
extracting an evidence pool from the data set to determine measure evidence;
calculating derivations based on the measure evidence;
calculating assertions based on the derivations and measure evidence; and
processing a set of rules based on the assertions to determine an initial population, numerator, and denominator.

17. The method of claim 16, further comprising:
determining a measure result based on the numerator and denominator.

18. The method of claim 11, further comprising:
receiving data in a first format; and
transforming the data from the first format into a uniform structure.

19. The method of claim 11, further comprising:
generating a report based on the result set.

20. A non-transitory machine-readable medium comprising a plurality of machine-readable instructions that when executed by one or more processors is adapted to cause the one or more processors to perform a method comprising:
receiving a measurement specification including a representation of a measure;
identifying, based on a measure schema, one or more components in the measurement specification;
generating, based on the identified one or more components, executable code;
receiving one or more parameters to apply to the measurement specification;
executing the executable code using the one or more parameters to extract data from a data set; and
storing a result set of the executed code in a database.
